(19) United States
(12) Patent Application Publication
(10) Pub. No.: US 2006/0070290 A1
(43) Pub. Date: Apr. 6, 2006

(54) Hook setting device

(76) Inventor: Henry Toy, Saskatoon (CA)

Correspondence Address: ADE & COMPANY INC., P.O. BOX 28006 1795 HENDERSON HIGHWAY, WINNIPEG, MB, R2G1P0, CA

(21) Appl. No.: 10/958,412

(22) Filed: Oct. 6, 2004

(51) Int. Cl. A01K 97/11

(52) U.S. Cl. 43/15

(57) ABSTRACT

A hook setting device is provided for setting a hook on a fishing line of a fishing rod. A rod holder supports the fishing rod and is movable relative to a base between an unset position and a set position is which the holder is biased to the unset position. A catch mechanism retains the holder in the set position while a sensing mechanism engages the fishing line for determining when a fish bit occurs. A link mechanism selectively couples the sensing mechanism to the catch mechanism so that sensitivity of the sensing mechanism can be adjusted in a safe manner without accidental release of the catch mechanism when the linking mechanism coupled therebetween is disengaged.

### FIELD OF THE INVENTION

The present invention relates to a hook setting device for setting a hook on a fishing line of a fishing rod.

### BACKGROUND

When fishing it is common practice to place bait on a hook at the end of a fishing line supported by a fishing rod. It is typical, when a fish first nibbles or bites into the bait, for the hook to initially not be fully caught within the mouth of the fish. A common fishing technique involves quickly pulling on the fishing line immediately once a first bite or nibble is sensed so that the hook can be set in the fish's mouth for subsequently reeling in the fish thus caught on the hook on the end of the fishing line. Being able to sense when a fish has bitten into the bait however requires skill and careful attention for long periods of time.

U.S. Pat. No. 5,570,534 to Ford, U.S. Pat. No. 5,524,376 to Flisak, U.S. Pat. No. 4,188,742 to Olman and U.S. Pat. No. 3,672,085 to King disclose automatic hook setting devices which automatically jerk the fishing rod upwardly once sufficient pressure is applied to the rod which may be indicative of a bite on the bait. In each of these examples however, the sensing mechanism only senses pressure applied to the rod itself and not just the fishing line. Due to the resilient nature of the tip of the fishing rod, significant force might be applied to the fishing line which would not be detected when only sensing deflection of the rod near the handle thereof and accordingly these examples lack required sensitivity for effective use.

U.S. Pat. No. 3,977,117 to Zahner and U.S. Pat. No. 5,873,191 to Bova et al. disclose further examples of an automatic fish hook setting device. In these devices, the sensing mechanism engages the fishing line directly so that the upward jerking motion of the fishing rod is released dependent upon line pressure which is more sensitive than deflection of the rod near the base thereof as in the above noted examples. Neither of these examples permit safe adjustment of the sensitivity of the line sensing mechanism while the rod is in the set position. Accordingly it is not possible to accurately adjust sensitivity of the fishing line to accommodate for various different fishing conditions encountered.

### SUMMARY

According to one aspect of the present invention there is provided hook setting device for setting a hook on a fishing line of a fishing rod, the device comprising:

a base for being supported on a supporting surface;

a rod holder for holding the fishing rod, the holder being movable relative to the base between an unset position and a set position in which the holder is biased to the unset position;

a catch mechanism for retaining the holder in the set position;

a sensing mechanism for engaging the fishing line of the fishing rod and including a sensing arm movable with the fishing line; and

a linking mechanism movable between an engaged position in which the catch mechanism is movable with the sensing mechanism to release the holder from the set position to the unset position and a disengaged position in which the sensing mechanism is movable independently of the catch mechanism.

The use of a linking mechanism operable between the sensing mechanism and the catch mechanism readily permits independent operation of the sensing mechanism as desired for safe adjustment thereof without possibility for accidental release of the rod holder into the unset positions. Once disengaged, the sensing arm deflection and spring biasing can be adjusted to compensate specifically for external forces such as drag when trolling or activation trigger pressure.

The device preferably includes a biasing member urging the sensing arm away from unsetting action of the rod holder in which the biasing force provided is adjustable.

The sensing arm may lie substantially perpendicular to a longitudinal direction of the rod holder in the set position.

The link mechanism preferably includes a lever which is movable over center between the engaged and disengaged positions respectively.

The catch mechanism may include a catch member which is pivotally supported on the base and which is preferably biased towards retention of the rod holder in the set position.

Biasing of the rod holder towards the set position may be adjustable.

The rod holder may comprise a tubular member for receiving a fishing rod handle therein which includes diametrically opposed slots formed in a free end thereof.

When a lock member is provided on the rod holder for retaining a reel of the fishing rod at one end thereof, an actuator of the lock member is preferably located at an opposite end thereof.

Displacement of the lock member from a locked position to an unlocked position may require resiliently deflecting the lock member from a seated position in the rod holder.

There may be provided a line clip supported on the rod holder for frictionally engaging a loop of fishing line therein. The line clip may be selectively separable from the rod holder and may include a pair of opposed clamping surfaces formed of resilient material under compression.

The base preferably includes an upright supporting the rod holder thereon and a ground engaging portion selectively pivotal relative to the upright.

The ground engaging portion may include legs which are foldable between a stored position and an extended position and which are selectively separable from the upright.

Alternatively, there may be provided a bracket for attachment to a supporting surface of a boat to which the base is selectively mounted for ready reattachment.

### BRIEF DESCRIPTION OF THE DRAWINGS

In the accompanying drawings, which illustrate exemplary embodiments of the present invention:

FIG. 1 is a side elevational view of the hook setting device.

FIG. 2 is an opposing side elevation view of the device including a fishing rod supported therein.

FIG. 3 is a perspective view of the linking mechanism operable between the sensing mechanism and the catch mechanism.

FIG. 4 is a perspective view of the spring biasing the rod holder to the unset position.

FIGS. 5 and 6 are top plan views of the link mechanism in the disengaged and engaged positions respectively.

FIG. 7 is a perspective view of the base of the device.

FIG. 8 is a perspective view of the rod holder.

FIG. 9 is an exploded perspective view of the rod holder.

FIGS. 10 and 11 are end views of the rod holder in respective first and second locking positions.

FIG. 12 is an enlarged perspective view of one of the slots of the rod holder.

FIG. 13 is a perspective view of a line clip for attachment to the rod holder.

FIG. 14 is a side elevation view of the base of the device.

FIGS. 15 and 16 are schematic views of further embodiments of the base in the form of brackets for attachment to various supporting surfaces of a boat for example.

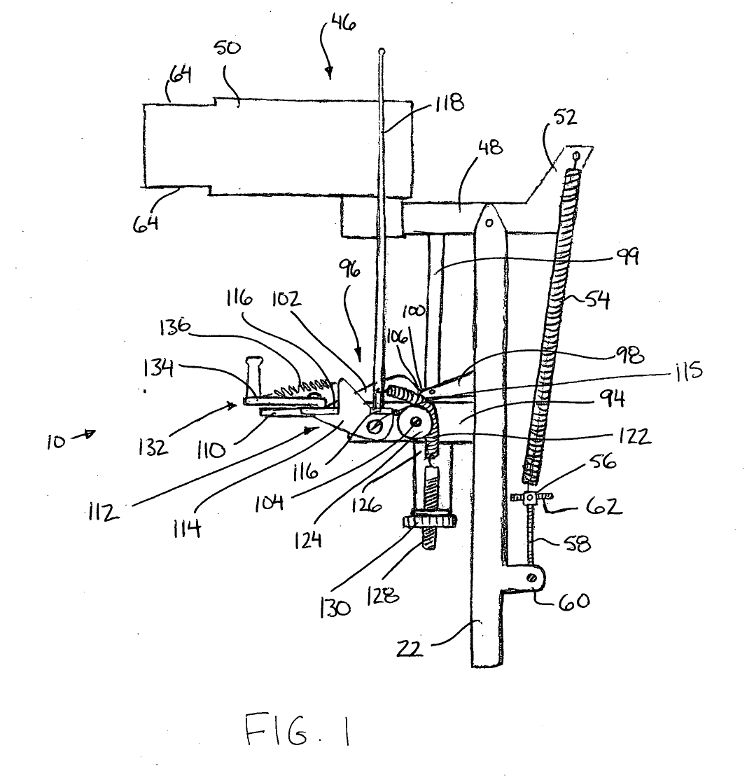

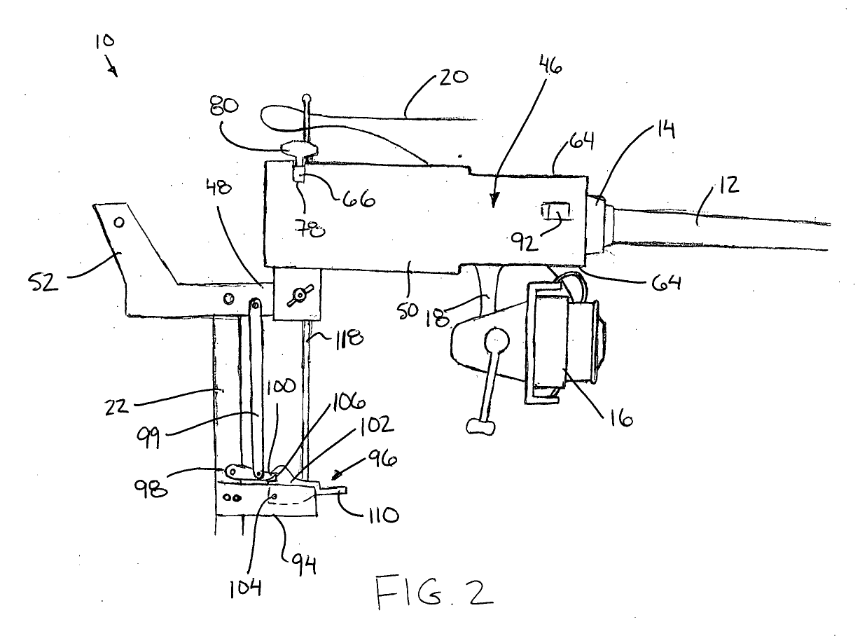

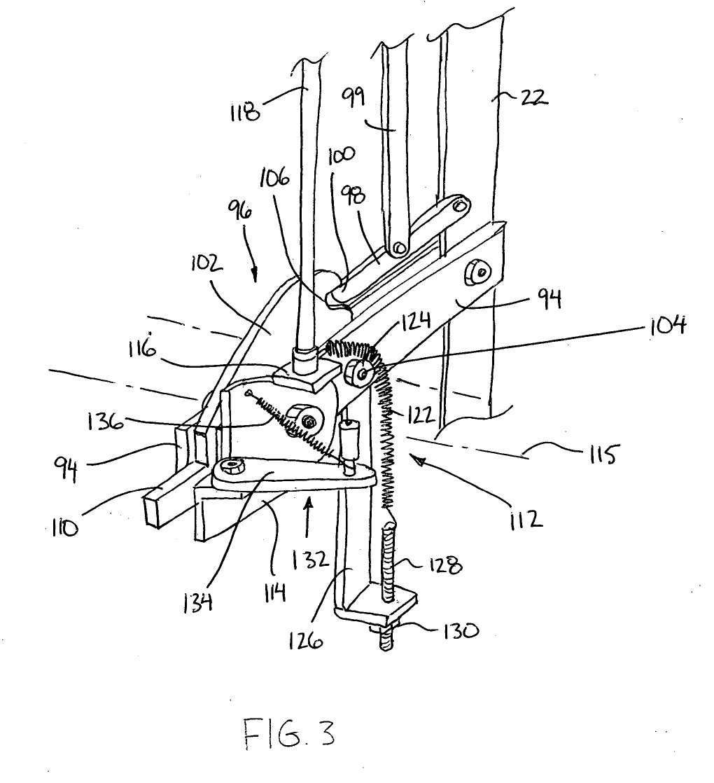

### DETAILED DESCRIPTION

Referring to the accompanying drawings, there is illustrated a hook setting device generally indicated by reference numeral 10. The device 10 is suitable for use with a conventional fishing rod 12 of the type having a handle 14 at one end thereof supporting a reel 16 thereon connected to the handle by a reel leg 18 spanning therebetween. The reel supports fishing line 20 thereon which extends form the reel to be supported alongside the rod 12 and subsequently extend beyond the rod to a free end supporting a hook thereon for catching fish.

The device 10 includes an upright 22 which comprises a main body element supporting the remainder of the components of the device thereon. An upright foot plate 24 is pivotally supported at a base of the upright 22 adjacent a top edge of the plate 24. A plurality of mounting holes 26 are spaced laterally apart across a bottom of the plate 24 below the pivot of the upright 22 for selective mounting to the bottom end of the upright 22. In this arrangement the upright 22 can be secured at one of several inclinations in relation to the foot plate 24. The foot plate 24 includes a base flange 28 which lies substantially perpendicular to the longitudinal direction of the upright 22 in a first mounted position of the foot plate 24. The base flange 28 includes suitable apertures therein for receiving studs or threaded fasteners which anchor the foot plate 24 to a suitable base member.

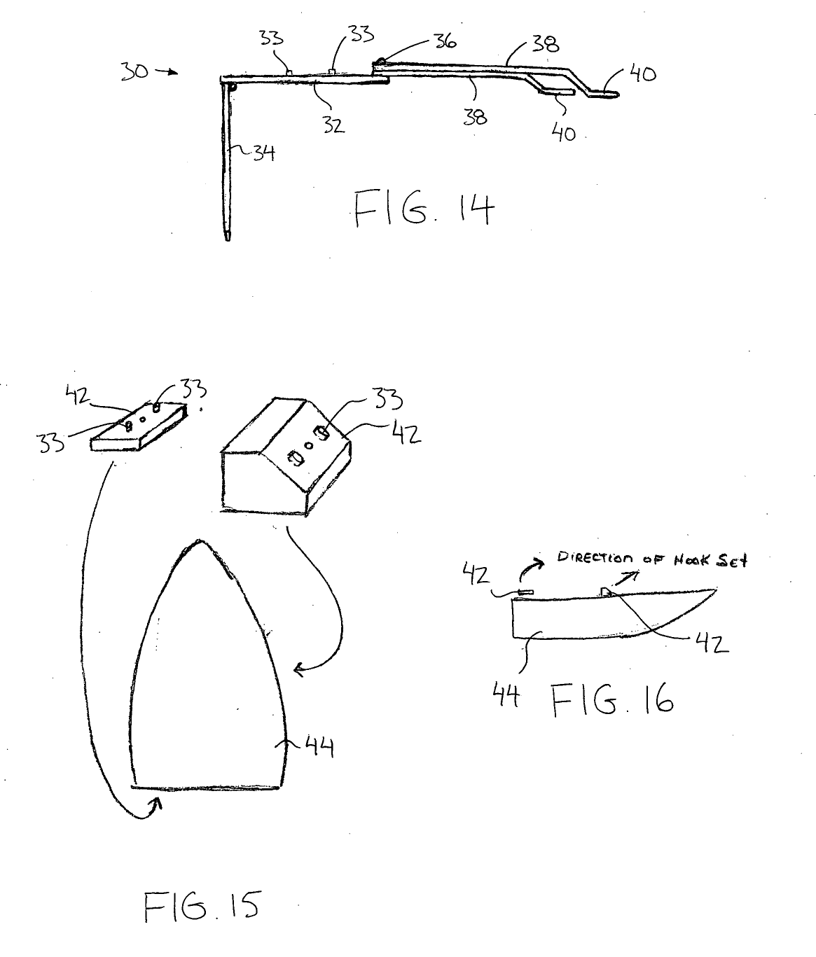

A first embodiment of the base member 30 is illustrated in FIGS. 7 and 14. An elongate rail 32 is provided with holes for attachment of suitable lugs 33 or threaded fasteners for mounting the foot plate thereon at various spaced positions therealong. A spike attachment 34 is selectively mounted at one end of the rail for engagement into the ground in certain applications. The opposing end of the rail includes a stop 36 supported thereon along the rail 32 between the ends thereof, a pair of legs 38 are connected at a common pivot adjacent the stop member and spaced upward from the surface of the rail 32 by suitable spacers. The legs are pivotal relative to the rail between a deployed position engaged on opposing sides of the stop 36 to form a generally Y-shaped configuration and a retracted position in which both legs lie overtop the rail 32 adjacent and parallel thereto. Suitable feet 40 are formed at the free ends of the legs at different longitudinal positions to permit the legs to be overlapped in the retracted position.

As illustrated in FIGS. 15 and 16 any suitable form of bracket 42 may be instead be provided for attachment to various supporting surfaces of a boat 44 for example. Each bracket includes suitable lugs 33 and apertures for receiving threaded fasteners to secure the base flange 28 of the foot of the upright 22 thereon.

A rod holder 46 is pivotally supported at the top end of the upright 22. The holder 46 includes a stem pivoted at its center on the upright 22. The stem 48 mounts an outer tube 50 at one end thereof for receiving the handle of the fishing rod therein. The tube 50 extends longitudinally parallel to the longitudinal direction of the stem 48. The stem projects opposite the tube 50 at a tail end formed by two spaced apart mounting plates 52. A tension spring 54 is attached to each of the tail plates 52 at a first end and is coupled to a common adjuster plate 56 at a bottom end. The adjuster plate 56 attaches the springs thereon at spaced positions on opposing sides of a threaded rod 58 received through the plate. A lower end of the threaded rod 58 is anchored to an anchor flange 60 connected to the upright adjacent the base thereof. Position of the adjuster plate 56 along the treaded rod 58 is controlled by a suitable nut 62 for adjusting the distance which the springs span in the set position of the holder and accordingly the tension of the springs in the set position is adjusted.

The outer tube 50 of the rod holder 46 is a cylindrical tube which is open ended. A free end of the tube opposite the stem 48 includes upper and lower slots 64 extending longitudinally inward from a free end of the tube at diametrically opposed positions. When the handle of a fishing rod is received within the tube 50, the reel leg 18 of the reel 16 is received within the appropriate top or bottom slot depending on whether the reel is mounted on the top side or bottom side of the rod.

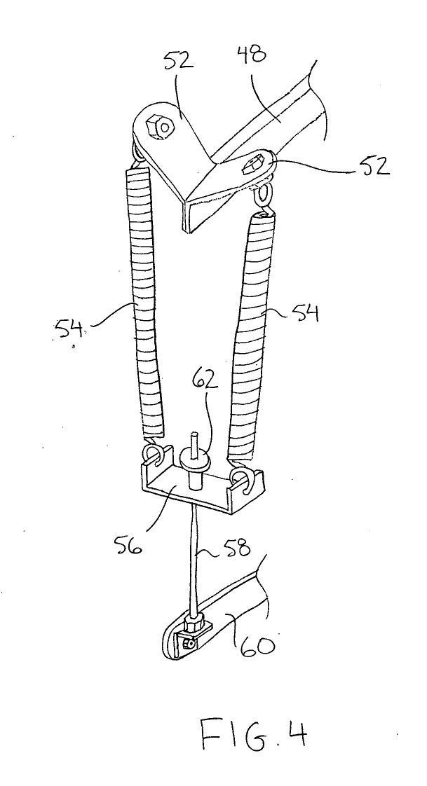

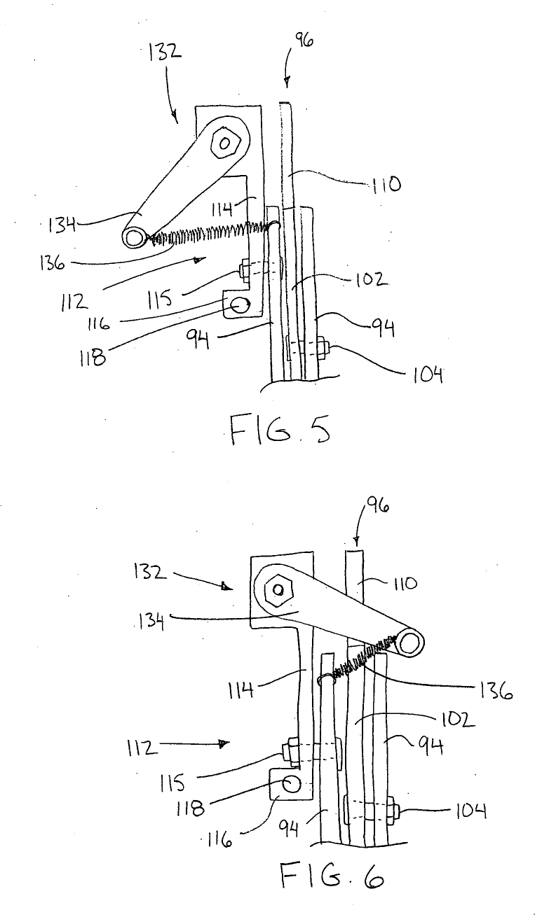

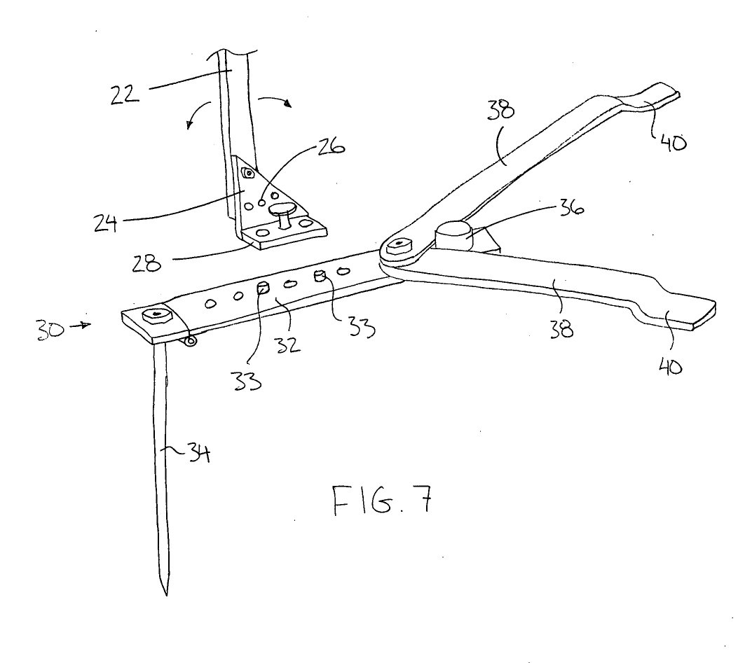

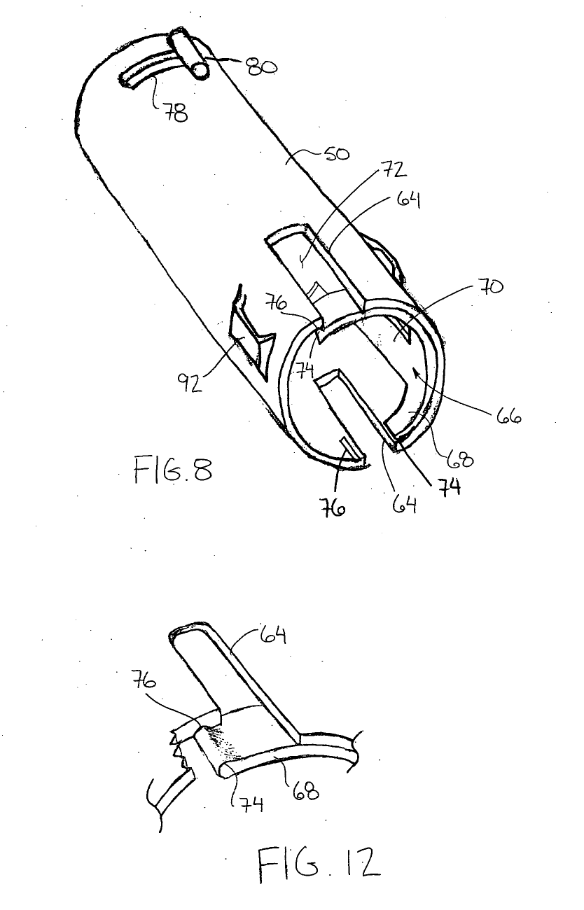

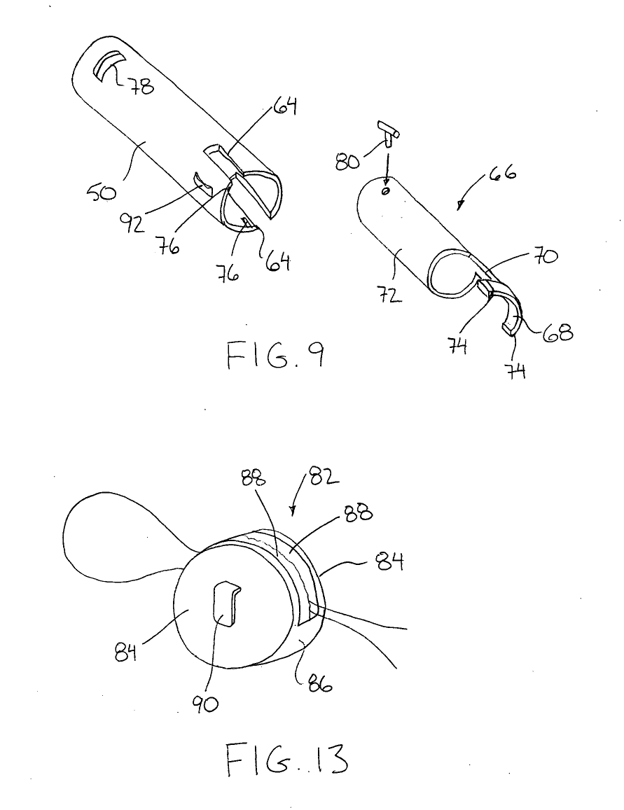

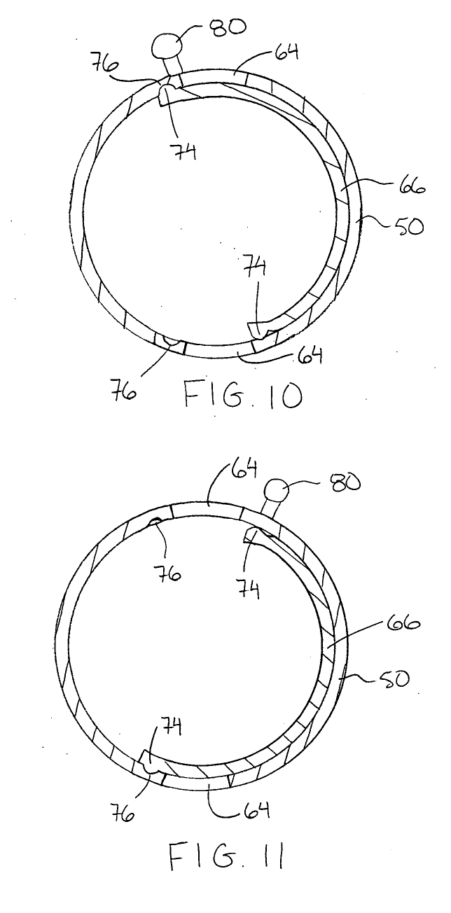

The outer tube 50 includes an inner tube 66 received concentrically therein for selectively locking either the top or bottom slots 64 closed for retaining the reel leg therein. The inner tube includes a C-shaped section 68 at a free end thereof which extends approximately 180 degrees about an inner circumference of the outer tube 50 so that the open end of only one of the slots 64 can be overlapped and closed at one time. A stem portion 70 spans between the C-shaped portion and a round body 72 of the inner tube 66. Each free end of the C-shaped section 68 includes a raised protrusion 74 formed thereon which is aligned within a respective recessed seat 76 formed along the inner surface of the outer tube 50. When the end of the C-shaped section is spanning its respective slot, the resiliency of the plastic material forming the liner tube 66 permits the raised portions 74 to be selectively received within the seats to be retained in the locking position. A slot 78 is provided in a circumferential direction in the outer tube 50 at an opposing end from the slots 64 for receiving a handle 80 connected to the inner tube 66 therethrough. Movement of the handle along the slot 78 thus rotates the C-shaped liner section 68 between the first and second locked positions of FIGS. 5 and 6 respectively.

Turning now to FIG. 13, a line clip 82 is illustrated for frictionally engaging a loop of fishing line adjacent the free end of the rod holder outer tube 50. The line clip 82 comprises a rigid shell formed of two sides 84 coupled at parallel and spaced apart positions by a base portion 86 spanning therebetween. The interior confronting faces of the sides 84 are lined with resilient pads 88 which are supported under compression between the sides 84 of the shells. A retainer clip 90 is mounted on the outer side of the shell forming the lined clip 82 for being received within a mating socket 92 on an outer surface of the outer tube 50 of the rod holder. The resilient material forming the pads 88 has a smooth surface so that a loop of fishing line can be wedged in between the pads and frictionally held therein as desired. The line clip thus permits a loop of fishing line to be let out before activation of the unsetting motion of the rod holder.

Two mounting bars 94 are supported parallel and spaced apart from one another on opposing sides of the upright. The bars 94 extend substantially horizontally, perpendicularly to the upright adjacent a mid point of the upright between the top and bottom ends thereof.

A catch mechanism 96 is supported between the mounting bars 94 for controlling when the rod holder is released from the set position to an unset position. The mechanism 96 includes a catch lever 98 pivotally supported at one end on the upright 22 just above the mounting bars 94. A link 99 is coupled between the stem 48 of the holder and the catch lever 98 spaced from the upright so that the link 99 lies generally parallel to the upright. The catch lever 98 is in turn supported substantially parallel to a longitudinal direction of the holder throughout pivoting movement of the holder relative to the upright due to the four bar linkage configuration formed between the upright, the stem of the holder, the catch leaver 98 and the link 99. The catch lever 98 projects beyond the link 99 to a free end 100 which selectively engages a catch member 102.

The catch member comprises an upright plate which is pivotally supported between the mounting bars 94 for pivotal movement about a horizontal axis 104. A notch 106 is formed at an inner end of the catch member 102 spaced inwardly towards the upright 22 from the pivot axis 104. The notch 106 is suitably formed for selectively receiving the free end 100 of the catch lever 98 therein in the set position of the rod holder. The notch 106 and the free end of the lever 98 include confronting faces which mate with one another and which are smooth for riding along one another as the holder is released into the unset position. The confronting face of the lever 98 faces upwardly while the engaging face of the notch 106 faces downwardly against the lever.

The catch member 102 is biased about its pivot access 104 to rotate in a manner that the engaging face 106 of the notch faces, that is the catch member 102 is biased downwardly at the inner end thereof towards the set position in which the lever is retained thereon. The biasing of the catch member 102 is limited so that the catch member is not rotated beyond the set position which might otherwise prevent the lever from being reset onto the notch of the catch member. The notch 106 is located directly above the pivot axis of the catch member in the set position.

The catch member 102 includes an actuator arm 110 which extends outwardly opposite the notch 106. Urging the actuator arm 110 downwardly against the direction of biasing causes the notch 106 to be displaced upwardly away from the stop member 108 into the direction which the engaging face of the free end 100 of the catch lever faces so as to subsequently release the lever from the notch.

The mounting bars 94 also support a sensing mechanism 112 of the hook setting device thereon. The sensing mechanism includes a sensor plate 114 which is supported parallel and spaced from the catch member 102 for rotation about a second pivot axis 115 spaced outwardly from the upright in relation to the axis 104 of the catch member.

The sensor plate 114 includes an arm mount 116 for supporting an upright sending arm 118 thereon. The sensing arm comprises an elongate lever which lies substantially perpendicularly the longitudinal direction of the rod holder in the set positions thereof. A spring mount on the sensor plate at an inner end thereof above the pivot mount connects to a suitable spring member 122. The spring member then extends about a fulcrum point 124 comprising a lug projecting from the mounting bar to a lower end of the spring supported on a suitable anchor 126.

The anchor comprises an elongate bar fixed to one of the mounting bars 94 to extend downwardly there from parallel to the upright to a flange at a bottom end there of which receives a threaded rod 128 therethrough. The spring mounts to the end of the threaded rod 128 while a suitable nut 130 supports the rod in relation to the flange at the bottom of the anchor bar 126 so that the rod height can be adjusted by the nut to correspondingly adjust spring tension applied to the sensing arm which urges the sensing arm towards the upright.

A free end of the sensor plate 114 supports a link mechanism 132 thereon. The link mechanism includes a horizontal lever 134 which is pivotal about an upright axis spaced outwardly from the pivot axis 104. A spring member is coupled between a handle at a free end of the lever 134 and the senor plate 114 at a location which is nearer to the upright than the location which the lever 134 is pivotally supported on the sensor plate.

The lever is pivotal from a disengaged position over center of the spring 136 to an engaged position. In the disengaged position the lever projects away from the catch member while the spring acts to bias the lever against the sensor plate. Once rotated over center to the engaged position, the lever overlaps the actuator arm of the catch member while the spring 136 acts to bias the lever into further engagement with the catch member. Accordingly when the link mechanism is engaged, downward deflection at free end of the sensor plate results in a similar downward deflection of the actuating arm of the catch member. This in turn acts to release the rod holder into the unset position.

The sensor arm 118 intersects the longitudinal direction of the rod holder in the set position adjacent an inner end of the holder so that that fishing line must be looped rearwardly past the reel towards the bottom end of the handle in order to be looped about the sensing arm. The generally perpendicular orientation of the sensing arm in relation to the rod holder in the set position permits the line to be held at various heights along the sensing arm in relation to the sensor plate for selecting various sensitivities of actuating force. The rod holder and mounting bars project from a common side of the upright so that as the line of the fishing rod is pulled by a fish biting, the force acts to pull the sensing arm away from the upright thus rotating the sensor plate in a direction so that the outer end supporting the link mechanism thereon is rotated downwardly along with the actuator arm of the catch member to release the holder.

Once the upright 22 is supported on a suitable supporting surface, the rod holder extends generally upwardly in the unset position. Setting the rod holder into the set position involves pivoting the rod holder downwardly into a substantially perpendicular orientation with the upright 22 against tension provided by the springs 54. The top side of the catch member and the bottom side of the catch lever have smooth curved surfaces which slide past one another in a camming action when setting the rod holder. The inner end of the catch member is thus permitted some slight deflection against the biasing thereof as it is engaged by the lever while the rod holder is displaced from the unset position to the set position.

Once the lever is aligned with the notch in the catch member, releasing the rod holder results in the rod holder remaining in the set position as retained by the catch member and catch lever. Sensitivity of the sensing mechanism can then be adjusted independently of movement of the catch member by placing the link mechanism in the disengaged position. The force of drag on the line when trolling and the trigger force can then be balanced with the spring force provided by the spring coupled to the sensing mechanism. Pulling on the line can be done to safely test the amount of force required to deflect the sensing arm without concern for accidentally releasing the rod holder into the unset position as long as the link mechanism remains in the disengaged position. Once suitable sensitivity of the sensing mechanism has been selected the device can then be armed by engaging the link mechanism.

As described above, a rod holder is provided for supporting a fishing rod therein. The rod holder is easily removed for storage, accommodates both top and bottom mounted reels, and securely holds them in place by means of a locking mechanism. By securing the rod to the device, greater versatility is offered to the angler in positioning the device for the most effective hook set. The rod holder portion can be suitable attached to a base and utilized independently of the main body as a stationary holder. Manipulation of the lock takes place at the rear of the unit and away from the potential obstacles of the reel and fishing line of the fishing rod.

With reference to the setting mechanism described above, by using the angler's fishing line as opposed to pressure exerted by the angler's rod to activate the device, a far greater level of sensitivity can be obtained. When the line itself is used to activate the hook setting motion, levering advantage can be utilized in the design of the mechanisms to allow for activation before the bend in the rod is significant.

The arrangement of the present invention allows the angler to determine the precise amount of force that is being applied to his line by current, boat speed, or lure weight without accidental activation of the hook setting motion. The function of the link mechanism allows the trigger catch and the sensing arm to act independently of each other when desired. By doing this the swing arm can be held in place without the possibility for activation and more complex safety type systems of the prior art are unnecessary. This also allows for the use of the sensing arm to act like a gauge of potential forces once the angler has placed his line. This arrangement provides the angler with a way to identify and neutralize the exact amount of force that is being applied to his line. If the setting is too light, premature activation of the hook setting motion can occur. Alternatively, if the setting is too great, the hook set will be delayed or not happen at all.

To avoid the hit and miss situation this invention allows the angler's rod to be held in what would be considered its loaded or cocked position without potential activation of the hook setting motion. From this position the angler can mimic the exact conditions that the device will be used in. By placing the line on the sensing arm, the sensing arm will move from its upright position by pressure exerted on the line. The sensing arm can therefore be used as a visual reference to determine the amount of force that is being applied to the line. Increasing pressure exerted by the sensing arm spring sufficiently to restore the arm to its upright position indicates that all present forces acting on the angler's line are effectively neutralized. The angler can then adjust for any additional pressure he would like to be indicative of a fish strike sufficient enough to impart the hook setting motion.

The levering advantage provided by the length of the sensing arm and the location of the holding mechanisms for the swing arm allows for very light pressures to affect the trigger and swing arm catches regardless of where the line is held on the sensing arm. Resistance to sensing arm movement beyond the light pressure needed to affect the catch comes solely from the spring that resists its movement. By providing sensitivity adjustment in this way, line placement along a levering arm critical for sensitivity adjustments can be eliminated.

The tilting feature to the main body of the device allows for the easy positioning or repositioning to the angle in which the rod is held. Devices without the ability to adjust for held rod angle once the unit is anchored in place can be troublesome. When positioning the device for use while trolling it requires the device to be positioned in such a fashion that the direction of an effective hook set is more horizontal than vertical.

Held rod angle also plays a part in the trolling method. When more than one line is being utilized it is necessary to disperse the lines along differing paths to avoid tangling the lines.

The removable line clip provides a convenient way for the angler presenting stationary baits to allow for a designated amount of line to be played out before activation of the hook setting motion.

As noted above, the present invention is a device that will provide a means to hold an angler's rod and impart a hook setting motion at the moment of a fish strike. This device provides adjustments for the amount of setting force, triggering pressure, and held rod angle. It is versatile in its use and can be utilized when fishing from shore, on a boat or through the ice. It is capable of holding securely most rods with top or bottom mounted reels and can aid the angler in employing hook setting techniques where it is desirable for a certain amount of line to be played out before imparting a hook setting motion. The device is designed for attachment to several bases to accommodate it for use in the above stated instances.

The rod holder portion of the device has a locking mechanism which consists of an inner tube that is shaped in such a fashion so that when it is rotated by its attaching handle it will prevent the passing of the reel leg through the slot cut in the outer shell and hold the rod secure within the device. To keep the locking portion from rotating when undesired the leading edge of the collar is fashioned with a risen tapered edge so it will be pressed inward upon rotation and the resiliency of the plastic is then utilized to provide sufficient force to seat it within the notched portion of the outer shell.

The location of the locking mechanism is either on top for top mounted reels or on the bottom for bottom mounted reels. There are protruding slots on the rod holder portion that will accommodate attachment of a line clip. The removable line clip provides a means for the angler who would like to allow for a designated amount of line to be played out before activation of the hook setting motion, for example when still fishing from shore, on the ice, or from a boat. The inner part of the line clip is lined with a non abrasive material so that when the angler places his line in the slot the pressure of the material provides resistance to the movement of the angler's line.

Once the rod has been locked into the device, pushing down on the rod holder portion will position it ready to impart the hook setting motion. When this arm is lowered the stepped catch is forced against the edge of the triggering catch by means of the connecting arm. The catch is held in place by spring pressure and once the swing arm is fully depressed it will return to its original position and hold the swing arm in position by contact with the stepped catch.

With the unit depressed the angler can place his line on the sensing arm and make adjustments to compensate for any pressure not desirable for activating the device. The angler can do this by adjusting the amount of tension that is exerted by the spring that opposes the movement of the sensing arm. Any force placed upon the angler's line by river current, boat speed, or lure weight will move the arm forward. Increasing spring pressure will restore the sensing arm to its upright desirable position. Once in this position the angler can adjust for the desired amount of additional pressure he would like to trigger the hook setting motion.

Once the angler is ready to begin fishing all he needs to do is position the activation arm over the trigger release so that when the sensing arm is moved forward by a fish strike it contacts and tilts the triggering catch so as to release the swing arm and impart the hook setting motion.

The amount of setting force delivered is determined by the amount of pretension on the set springs before the swing arm is depressed. Adjustment for setting pressure in this model is provided by means of a threaded bar and knob. When the knob is rotated it will alter the amount of force exerted by the set springs by raising and lowering their anchoring point.

The scissoring base folds upon itself for compact storage and provides a stable platform for ice fishing and from shore when unfolded. When fishing from shore the ground spike is unfolded by hinged means and pressed into the ground for added stability. In its folded state it levels the platform with the two scissoring legs. When ice fishing, the base provides sufficient stability against the downward pull of the line by a fish.

The two other bases described herein allow for attachment to a boat so that positions convenient for holding and desirable for an efficient hook setting direction can be obtained.

While some embodiments of the present invention have been described in the foregoing, it is to be understood that other embodiments are possible within the scope of the invention. The invention is to be considered limited solely by the scope of the appended claims.

1. A hook setting device for setting a hook on a fishing line of a fishing rod, the device comprising:
a base for being supported on a supporting surface;
a rod holder for holding the fishing rod, the holder being movable relative to the base between an unset position and a set position in which the holder is biased to the unset position;
a catch mechanism for retaining the holder in the set position;
a sensing mechanism for engaging the fishing line of the fishing rod and including a sensing arm movable with the fishing line; and
a linking mechanism movable between an engaged position in which the catch mechanism is movable with the sensing mechanism to release the holder from the set position to the unset position and a disengaged position in which the sensing mechanism is movable independently of the catch mechanism.

2. The device according to claim 1 wherein there is provided a biasing member urging the sensing arm away from unsetting action of the rod holder.

3. The device according to claim 2 wherein biasing force provided by the biasing member is adjustable.

4. The device according to claim 1 wherein the sensing arm lies substantially perpendicular to a longitudinal direction of the rod holder in the set position.

5. The device according to claim 1 wherein the link mechanism includes a lever which is movable over center between the engaged and disengaged positions respectively.

6. The device according to claim 1 wherein the catch mechanism includes a catch member which is pivotally supported on the base.

7. The device according to claim 6 wherein the catch member is biased towards retention of the rod holder in the set position.

8. The device according to claim 1 wherein biasing of the rod holder towards the set position is adjustable.

9. The device according to claim 1 wherein the rod holder comprises a tubular member for receiving a fishing rod handle therein and which includes diametrically opposed slots formed in a free end thereof.

10. The device according to claim 1 wherein the rod holder comprises a tube for receiving a fishing rod handle therein which includes a lock member for retaining a reel of the fishing rod at one end thereof and an actuator of the lock member at an opposite end thereof.

11. The device according to claim 10 wherein displacement of the lock member from a locked position to an unlocked position requires resiliently deflecting the lock member from a seated position in the rod holder.

12. The device according to claim 1 wherein there is provided a line clip supported on the rod holder for frictionally engaging a loop of fishing line therein.

13. The device according to claim 12 wherein the line clip is selectively separable from the rod holder.

14. The device according to claim 12 wherein the line clip includes a pair of opposed clamping surfaces formed of resilient material under compression.

15. The device according to claim 1 wherein the base includes an upright supporting the rod holder thereon and a ground engaging portion selectively pivotal relative to the upright.

16. The device according to claim 15 wherein the ground engaging portion includes legs which are foldable between a stored position and an extended position.

17. The device according to claim 16 wherein the legs are selectively separable from the upright.

18. The device according to claim 1 wherein there is provided a bracket for attachment to a supporting surface of a boat to which the base is selectively mounted for ready reattachment.
